(19) United States
(12) Patent Application Publication
(10) Pub. No.: US 2024/0329944 A1
(43) Pub. Date: Oct. 3, 2024

(54) DYNAMIC MICROSERVICES MANAGEMENT AND CODE GENERATION

(71) Applicant: International Business Machines Corporation, Armonk, NY (US)

(72) Inventors: Andrea Cabrera Galindo, Tlalnepantla de Baz (MX); Catalina Albornoz Anzola, Toronto (CA); Ana Vialeny Mota Gómez, Cuernavaca (MX); Mohamed Zouhaier Ramadhane, Azcapotzalco (MX)

(73) Assignee: International Business Machines Corporation, Armonk, NY (US)

(21) Appl. No.: 18/129,626

(22) Filed: Mar. 31, 2023

(51) Int. Cl. G06F 8/36; G06F 8/71

(52) U.S. Cl. CPC G06F 8/36; G06F 8/71

(57) ABSTRACT

A first function of a first microservice and a second function of a second microservice are derived from data of an application using a plurality of microservices. From the first function and the second function, an embodiment determines that the first microservice and the second microservice have above a threshold similarity with each other. An embodiment determines a set of differences between the first microservice and the second microservice. New source code of the application is generated, the new source code utilizing the first microservice instead of the second microservice, the first microservice selected using the set of differences.

### BACKGROUND

The present invention relates generally to a method, system, and computer program product for microservices management. More particularly, the present invention relates to a method, system, and computer program product for dynamic microservices management and code generation.

A microservice architecture—a variant of the service-oriented architecture structural style—is an architectural pattern that arranges an application as a collection of loosely coupled microservices or simply services (the terms microservices and services are used interchangeably herein). The services communicate through lightweight protocols. Much like a function or method within an application that is not services-based, each service is architected to perform a task independently of other services. Within an application, services can execute on different system from each other, and service instances can be deployed or removed quickly, thus adapting application throughput to current requirements.

### SUMMARY

The illustrative embodiments provide a method, system, and computer program product. An embodiment includes a method that derives, from data of an application using a plurality of microservices, a first function of a first microservice and a second function of a second microservice. An embodiment determines, from the first function and the second function, that the first microservice and the second microservice have above a threshold similarity with each other. An embodiment determines a set of differences between the first microservice and the second microservice. An embodiment causes generating of new source code of the application, the new source code utilizing the first microservice instead of the second microservice, the first microservice selected using the set of differences.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for dynamic microservices management and code generation in accordance with an illustrative embodiment;

FIG. 3 depicts an example of dynamic microservices management and code generation in accordance with an illustrative embodiment;

FIG. 4 depicts a continued example of dynamic microservices management and code generation in accordance with an illustrative embodiment;

FIG. 5 depicts a flowchart of an example process for dynamic microservices management and code generation in accordance with an illustrative embodiment.

### DETAILED DESCRIPTION

The illustrative embodiments recognize that the microservices an application uses are often developed by different developers and teams, independently of each other, without a centralized planning authority enforcing application architecture or partitioning. As a result, individual developers often have little insight into the microservices that already exist, and the functions those microservices perform. Without this insight, a developer needing to add particular functionality to an application simply creates a new microservice implementing the desired functionality, even when an existing service might service just as well. Over time, an application code base might include thousands of microservices, many near-duplicates of each other, unnecessarily increasing application code size and development time, and making code maintenance unnecessarily difficult. Thus, the illustrative embodiments recognize that there is a need to improve microservices management by consolidating near-duplicate microservices and implementing new code using existing microservices.

The illustrative embodiments recognize that the presently available tools or solutions do not address these needs or provide adequate solutions for these needs. The illustrative embodiments used to describe the invention generally address and solve the above-described problems and other problems related to dynamic microservices management and code generation.

An embodiment can be implemented as a software application. The application implementing an embodiment can be configured as a modification of an existing microservices management system, as a separate application that operates in conjunction with an existing microservices management system, a standalone application, or some combination thereof.

Particularly, some illustrative embodiments provide a method including deriving, from data of an application using a plurality of microservices, a first function of a first microservice and a second function of a second microservice, determining, from the first function and the second function, that the first microservice and the second microservice have above a threshold similarity with each other, determining a set of differences between the first microservice and the second microservice, generating, using the first function, the second function, and the set of differences, a reconfiguration plan specifying an adjustment to source code of the application, and generating new source code of the application according to the reconfiguration plan.

An embodiment receives data of an application using microservices. In embodiments, the data includes one or more of runtime data, data from a code repository storing microservice source code, microservice source code documentation, and previous service implementation decisions of a user. Some non-limiting examples of runtime data are service and system performance data (e.g., a resource usage, such as processor, memory, energy, or storage, of a service), data of communications between services (e.g., service 1 exchanges messages with services 2 and 3, while service 4 does not exchange messages with any other service), a data source, sink, or runtime dependency of the set of microservices (e.g., a database or Uniform Resource Locator (URL)), logs including application execution data, and the like. Some non-limiting examples of data from a code repository are the source code itself, comments within the source code, dependencies within the source code (e.g., module 1 of service 1 exchanges messages with services 2 and 3, while module 2 of service 1 interacts only with other modules within service 1), the computer language of a service, and test results, results of a code quality evaluation tool, and security assessment results of the set of services, and the like. Some non-limiting examples of data from microservice source code documentation are application program interface (API) definitions, descriptions of how to use the set of services, and the like.

An embodiment uses one or more presently available techniques to identify a function of a microservice in the set of microservices. For example, source code typically includes, as comments, a human-language description of the functionality of a source code module or functions within a source code module. Thus, one embodiment uses a presently available natural language understanding technique to derive a microservice's function from this human-language description. Another embodiment uses a presently available natural language understanding technique to derive a microservice's function from API definitions or other documentation of the microservice. Another embodiment uses a presently available semantic analysis technique, for example a technique included in a presently available large language model that understands source code, to derive a microservice's function from source code of the microservice. Another embodiment uses code test results to determine a microservice's function. For example, an embodiment might conclude that, given certain input data and corresponding output data of a microservice, one microservice adds input numbers together while another microservice returns the date and time in a particular format. Another embodiment uses one or more presently available techniques to identify more than one function of a microservice in the set of microservices. For example, a microservice might include a portion that sums two numbers, and another portion that returns the date and time in a particular format.

An embodiment uses one or more presently available techniques to identify any data sources or sinks used by a microservice, and map relationships between microservices. For example, one embodiment uses a natural language understanding technique or code understanding technique to derive data sources used by a microservice and interactions or other relationships between microservices from source code or documentation of the service, from log data of a microservice's transactions with a data source or sink (e.g., database log data), or from another type of data. Another embodiment uses a presently available microservice discovery and monitoring tool, such as Instana, to identify any data sources or sinks used by a microservice and map relationships between microservices. (Instana is a registered trademark of International Business Machines Corporation in the United States and other countries.)

An embodiment uses functions, data sources, and relationships between microservices to determine that two microservices have above a threshold similarity to each other, and identifies a set of differences between two similar microservices.

For example, consider four services implemented in different computer languages. The requirements documentation or the code comments of services A, B, C and D includes, respectively, “receive 2 number and register the sum in the result database”, “do the sum of the 2 received number and register in the result database”, “multiply the 2 number that it receives and register in the result database”, “give the date and time right now”. Thus, using a natural language understanding technique, an embodiment might determine that service A has above a threshold similarity to service B, because both perform sums, and both have below a threshold similarity to service C (which performs multiplication) and service D (which reports the date and time). By analyzing runtime data, an embodiment might conclude that services A, B, and C use the same resource, a results database. By analyzing runtime data, an embodiment might also conclude that every time services A and B receive the same input, they gave the same output (e.g., given inputs of 1 and 2, the result is 3). As a result, an embodiment might conclude that services A and B have above a threshold similarity to each other with a probability of 99%, that services A and C have above a threshold similarity to each other with a probability of 30%, that services B and C have above a threshold similarity to each other with a probability of 30%, that services A and D have above a threshold similarity to each other with a probability of 1%, and that services B and D have above a threshold similarity to each other with a probability of 1%. In addition, by analyzing the runtime data, an embodiment determines that service A is written in a different programming language than service B, that service A processes transactions in an average time of 0.2 millisecond, while service B processes transactions in an average time of 0.5 millisecond, and that processor and memory usage are lower for service A then for service B. Thus, an embodiment might conclude that the service A is more energy efficient and performs faster than service B. In addition, the data collected by a presently available quality evaluation tool indicates that service A has a higher quality score (meaning better quality code) than service B.

An embodiment uses the microservices identified as sufficiently similar to each other, and the set of differences between two similar microservices, to generate a microservice reconfiguration plan. Optionally, an embodiment also uses one or more of a user preference (e.g., for one programming language over another in deciding which of two similar services to keep), a policy (e.g., all service implementations are to be implemented in a particular programming language, or a particular service must be implemented in a particular country due to data protection regulations), and the results of previous user decisions in generating the reconfiguration plan. The reconfiguration plan includes one or more of using one microservice instead of another, extending an existing microservice with an optional parameter to include an additional use case (so as to replace an existing microservice with the now-extended microservice), combining two microservices into one, dividing one microservice into two portions, and the like. In one embodiment, the microservice reconfiguration plan includes a relationship map, a graphical representation of the data, or types of data, used to generate the plan.

For example, continuing the example of service A, B, C, and D, an embodiment might conclude that, because services A and B perform the same function but service A is faster and has higher code quality than service B, service A should be used instead of service B. Thus, an embodiment generates a microservice reconfiguration plan that plans to replace calls to service B with calls to service A, and disabling or removing service B once it is no longer being called by other code.

As a variation of the example, suppose service A adds four numbers together, while service B adds two numbers together. By analyzing usage history data of the services, an embodiment might conclude that services A and B provide the same results as long as two of the inputs into service A are zero. An embodiment might perform unit tests to confirm that the task performed by service B is contained in service A. Thus, an embodiment generates a microservice reconfiguration plan that plans to replace calls to service B with calls to service A, including setting two of the input parameters to zero to ensure the same results as service B provided. The plan might also include disabling or removing service B once it is no longer being called by other code.

As another variation of the example, suppose service E also exists, that includes a portion that adds two numbers together and another portion that reports the date and time. The summation portion is sufficiently similar to service A, and the date and time portion is sufficiently similar to service D. Thus, an embodiment generates a microservice reconfiguration plan that plans to replace calls to the summation portion of service E with calls to service A (including adjusting input parameters if necessary), and plans to replace calls to the date and time portion of service E with calls to service D. The plan might also include disabling or removing service E once it is no longer being called by other code. Alternatively, if neither of the two portions is sufficiently similar to an existing service, an embodiment generates a microservice reconfiguration plan that splits the two portions of service E into different services.

An embodiment presents the microservice reconfiguration plan to a human user for review. The user has the opportunity to accept, accept with a modification, or reject the plan or a portion of the plan. An embodiment records the user's decision for use in generating future reconfiguration plans.

An embodiment reconfigures a microservice implementation according to an approved microservice reconfiguration plan. Another embodiment omits the plan approval step, and reconfigures a microservice implementation according to a generated microservice reconfiguration plan. To reconfigure a microservice implementation according to a reconfiguration plan, one embodiment uses a presently available code generation tool to generate code that calls one microservice instead of another, extends code of an existing microservice to include an optional parameter implementing an additional use case (so as to replace an existing microservice with the now-extended microservice), combines code of two microservices into one, divides code of one microservice into two portions, and the like. One non-limiting example of a presently available code generation tool is GitHub Copilot. (GitHub Copilot is a registered trademark of GitHub, Inc. in the United States and other countries.)

An embodiment tests, or causes to be tested, the reconfigured microservice implementation. If an error results, or performance of the reconfigured microservice implementation does not meet a performance improvement criterion, an embodiment uses the test results to generate and implements a different microservice implementation plan in a manner described herein. One embodiment tests the reconfigured microservice implementation in a test environment, so as not to impact a currently executing application.

An embodiment works with a presently available code generation tool to specify a function of a candidate microservice intended to be used from code being generated, as well as identify any data sources or sinks to be used by a candidate microservice, and maps relationships between the candidate microservice and existing microservices. In particular, an embodiment receives data of the candidate microservice from the code generation tool, derives a function of the candidate microservice from the data of the candidate microservice, identifies a microservice having above a threshold similarity to the candidate microservice and a set of differences between the identified microservice and the candidate microservice, and uses the similar microservice and the set of differences to formulate a new functionality plan implementing the function of the candidate microservice in a manner described herein. For example, a user might have entered instructions in a presently available code generation tool indicating that the user needs a service that returns the current date and time. The new functionality plan includes, for example, a recommendation of an existing service with above a threshold similarity to the candidate microservice, or a recommended modification to the existing service to accommodate functionality of the candidate microservice.

Another embodiment receives data of the candidate microservice from the code generation tool, derives a function of the candidate microservice from the data of the candidate microservice, determines that no existing microservice has above a threshold similarity to the candidate microservice, and formulates a new functionality plan implementing the candidate microservice.

An embodiment presents the new functionality plan to a user for approval, and uses the presently available code generation tool to implement the approved new functionality plan in a manner described herein. Another embodiment omits the plan approval step, and uses the presently available code generation tool to implement the generated new functionality plan in a manner described herein.

The manner of dynamic microservices management and code generation described herein is unavailable in the presently available methods in the technological field of endeavor pertaining to microservices management and implementation. A method of an embodiment described herein, when implemented to execute on a device or data processing system, comprises substantial advancement of the functionality of that device or data processing system in deriving, from data of an application using a plurality of microservices, a first function of a first microservice and a second function of a second microservice, determining, from the first function and the second function, that the first microservice and the second microservice have above a threshold similarity with each other, determining a set of differences between the first microservice and the second microservice, generating, using the first function, the second function, and the set of differences, a reconfiguration plan specifying an adjustment to source code of the application, and generating new source code of the application according to the reconfiguration plan.

The illustrative embodiments are described with respect to certain types of microservices, functions, data sources and sinks, relationships, similarities, differences, tools, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

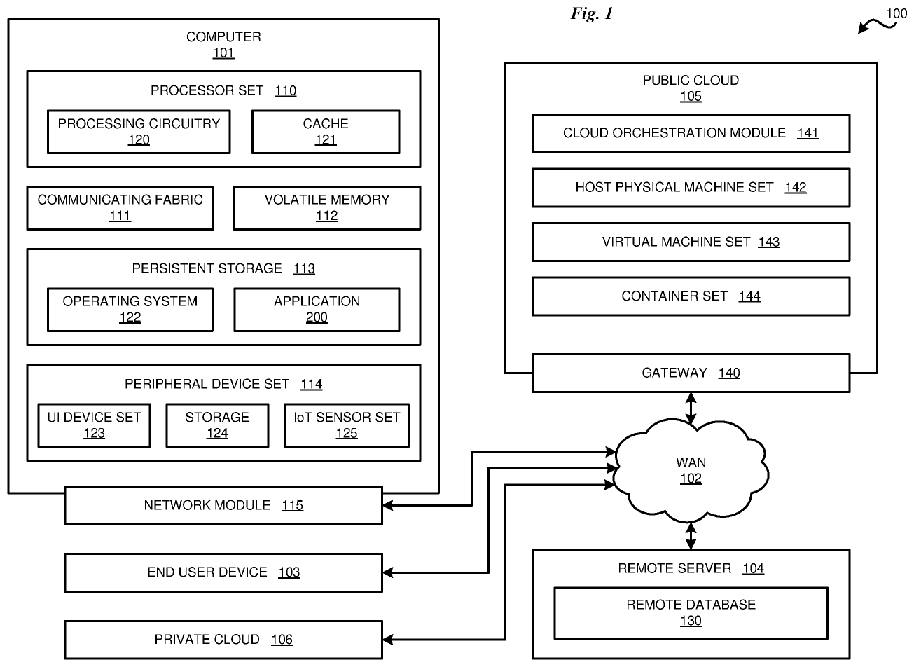

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a dynamic microservices management and code generation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

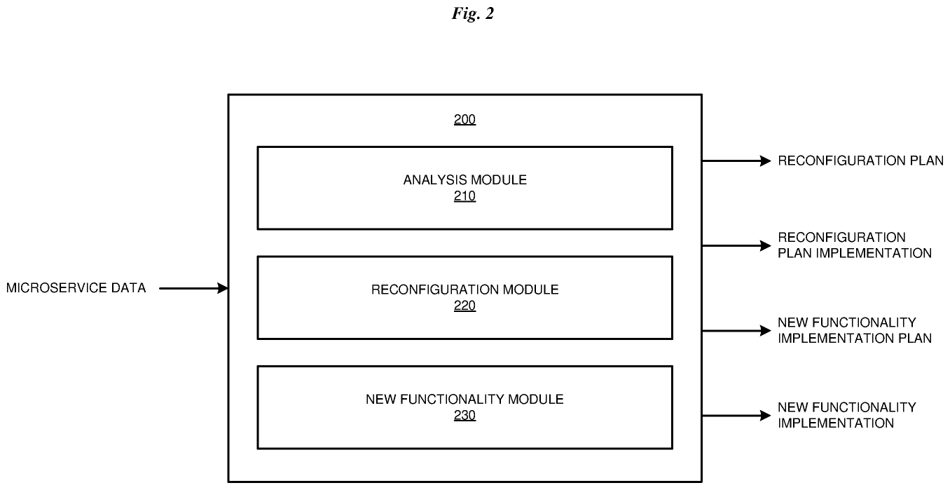

With reference to FIG. 2, this figure depicts a block diagram of an example configuration for dynamic microservices management and code generation in accordance with an illustrative embodiment. Application 200 is the same as application 200 in FIG. 1.

Application 200 receives data of an application using microservices, including one or more of runtime data, data from a code repository storing microservice source code, microservice source code documentation, and previous service implementation decisions of a user. Some non-limiting examples of runtime data are service and system performance data (e.g., a resource usage, such as processor, memory, energy, or storage, of a service), data of communications between services (e.g., service 1 exchanges messages with services 2 and 3, while service 4 does not exchange messages with any other service), a data source, sink, or runtime dependency of the set of microservices (e.g., a database or Uniform Resource Locator (URL)), logs including application execution data, and the like. Some non-limiting examples of data from a code repository are the source code itself, comments within the source code, dependencies within the source code (e.g., module 1 of service 1 exchanges messages with services 2 and 3, while module 2 of service 1 interacts only with other modules within service 1), the computer language of a service, and test results, results of a code quality evaluation tool, and security assessment results of the set of services, and the like. Some non-limiting examples of data from microservice source code documentation are application program interface (API) definitions, descriptions of how to use the set of services, and the like.

Analysis module 210 uses one or more presently available techniques to identify a function of a microservice in the set of microservices. For example, source code typically includes, as comments, a human-language description of the functionality of a source code module or functions within a source code module. Thus, one implementation of module 210 uses a presently available natural language understanding technique to derive a microservice's function from this human-language description. Another implementation of module 210 uses a presently available natural language understanding technique to derive a microservice's function from API definitions or other documentation of the microservice. Another implementation of module 210 uses a presently available semantic analysis technique, for example a technique included in a presently available large language model that understands source code, to derive a microservice's function from source code of the microservice. Another implementation of module 210 uses code test results to determine a microservice's function. For example, module 210 might conclude that, given certain input data and corresponding output data of a microservice, one microservice adds input numbers together while another microservice returns the date and time in a particular format. Another implementation of module 210 uses one or more presently available techniques to identify more than one function of a microservice in the set of microservices. For example, a microservice might include a portion that sums two numbers, and another portion that returns the date and time in a particular format.

Module 210 uses one or more presently available techniques to identify any data sources or sinks used by a microservice, and map relationships between microservices. For example, one implementation of module 210 uses a natural language understanding technique or code understanding technique to derive data sources used by a microservice and interactions or other relationships between microservices from source code or documentation of the service, from log data of a microservice's transactions with a data source or sink (e.g., database log data), or from another type of data. Another implementation of module 210 uses a presently available microservice discovery and monitoring tool, such as Instana, to identify any data sources or sinks used by a microservice and map relationships between microservices.

Module 210 uses functions, data sources, and relationships between microservices to determine that two microservices have above a threshold similarity to each other, and identifies a set of differences between two similar microservices.

Reconfiguration module 220 uses the microservices identified as sufficiently similar to each other, and the set of differences between two similar microservices, to generate a microservice reconfiguration plan. Optionally, module 220 also uses one or more of a user preference (e.g., for one programming language over another in deciding which of two similar services to keep), a policy (e.g., all service implementations are to be implemented in a particular programming language, or a particular service must be implemented in a particular country due to data protection regulations), and the results of previous user decisions in generating the reconfiguration plan. The reconfiguration plan includes one or more of using one microservice instead of another, extending an existing microservice with an optional parameter to include an additional use case (so as to replace an existing microservice with the now-extended microservice), combining two microservices into one, dividing one microservice into two portions, and the like. In one implementation of module 220, the microservice reconfiguration plan includes a relationship map, a graphical representation of the data, or types of data, used to generate the plan.

Application 200 presents the microservice reconfiguration plan to a human user for review. The user has the opportunity to accept, accept with a modification, or reject the plan or a portion of the plan. Module 220 records the user's decision for use in generating future reconfiguration plans.

Module 220 reconfigures a microservice implementation according to an approved microservice reconfiguration plan. Another implementation of module 220 omits the plan approval step, and reconfigures a microservice implementation according to a generated microservice reconfiguration plan. To reconfigure a microservice implementation according to a reconfiguration plan, one implementation of module 220 uses a presently available code generation tool to generate code that calls one microservice instead of another, extends code of an existing microservice to include an optional parameter implementing an additional use case (so as to replace an existing microservice with the now-extended microservice), combines code of two microservices into one, divides code of one microservice into two portions, and the like. One non-limiting example of a presently available code generation tool is GitHub Copilot.

Application 200 tests, or causes to be tested, the reconfigured microservice implementation. If an error results, or performance of the reconfigured microservice implementation does not meet a performance improvement criterion, module 220 uses the test results to generate and implements a different microservice implementation plan in a manner described herein. One embodiment tests the reconfigured microservice implementation in a test environment, so as not to impact a currently executing application.

New functionality module 230 works with a presently available code generation tool to specify a function of a candidate microservice intended to be used from code being generated, as well as identify any data sources or sinks to be used by a candidate microservice, and maps relationships between the candidate microservice and existing microservices. In particular, application 200 receives data of the candidate microservice from the code generation tool, derives a function of the candidate microservice from the data of the candidate microservice, and identifies a microservice having above a threshold similarity to the candidate microservice and a set of differences between the identified microservice and the candidate microservice. Module 230 uses the similar microservice and the set of differences to formulate a new functionality plan implementing the function of the candidate microservice in a manner described herein. For example, a user might have entered instructions in a presently available code generation tool indicated that the user needs a service that returns the current date and time. The new functionality plan includes, for example, a recommendation of an existing service with above a threshold similarity to the candidate microservice, or a recommended modification to the existing service to accommodate functionality of the candidate microservice.

Another implementation of application 200 receives data of the candidate microservice from the code generation tool, derives a function of the candidate microservice from the data of the candidate microservice, and determines that no existing microservice has above a threshold similarity to the candidate microservice. Module 230 formulates a new functionality plan implementing the candidate microservice.

Module 230 presents the new functionality plan to a user for approval, and uses the presently available code generation tool to implement the approved new functionality plan in a manner described herein. Another implementation of module 230 omits the plan approval step, and uses the presently available code generation tool to implement the generated new functionality plan in a manner described herein.

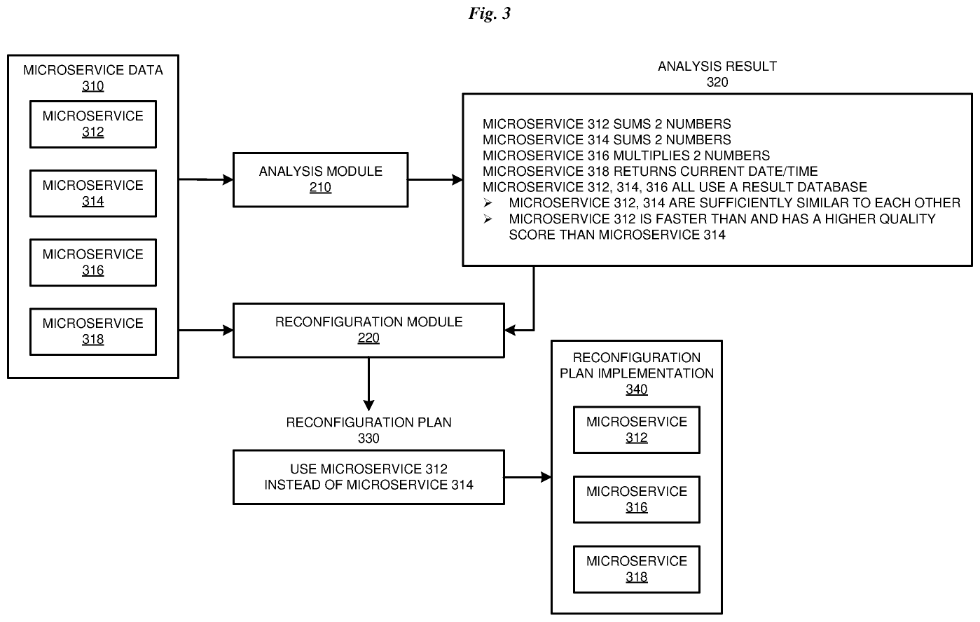

With reference to FIG. 3, this figure depicts an example of dynamic microservices management and code generation in accordance with an illustrative embodiment. The example can be executed using application 200 in FIG. 2. Analysis module 210 and reconfiguration module 220 are the same as analysis module 210 and reconfiguration module 220 in FIG. 2.

Analysis module 210 receives microservice data 310, including data of microservices 312, 314, 316, and 318. The requirements documentation or the code comments of services 312, 314, 316, and 318 includes, respectively, “receive 2 number and register the sum in the result database”, “do the sum of the 2 received number and register in the result database”, “multiply the 2 number that it receives and register in the result database”, “give the date and time right now”. Thus, using a natural language understanding technique, module 210 determines that service 312 has above a threshold similarity to service 314, because both perform sums, and both have below a threshold similarity to service 316 (which performs multiplication) and service 318 (which reports the date and time). By analyzing runtime data, module 210 concludes that services 312, 314, and 316 use the same resource, a results database. By analyzing runtime data, module 210 concludes that every time services 312 and 314 receive the same input, they gave the same output (e.g., given inputs of 1 and 2, the result is 3). As a result, module 210 concludes analysis result 320: that services 312 and 314 have above a threshold similarity to each other. In addition, by analyzing the runtime data, module 210 determines that (also summarized in analysis result 320) service 312 processes transactions in an average time of 0.2 millisecond, while service 314 processes transactions in an average time of 0.5 millisecond, and that service 312 has a higher quality score (meaning better quality code) than service 314.

As a result, reconfiguration module 220 uses analysis result 320 to generate microservice reconfiguration plan 330, including using microservice 312 instead of microservice 314. Thus, in reconfiguration plan implementation 340, module 220 uses a presently available code generation tool to generate code that calls microservice 312 instead of microservice 314, thus removing microservice 314 from service.

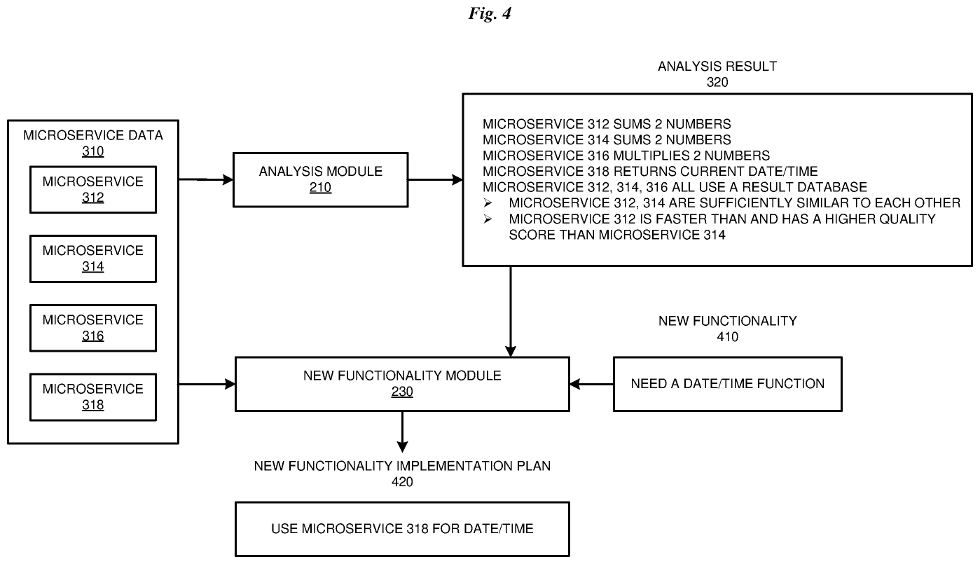

With reference to FIG. 4, this figure depicts a continued example of dynamic microservices management and code generation in accordance with an illustrative embodiment. Analysis module 210 and new functionality module 230 are the same as analysis module 210 and new functionality module 230 in FIG. 2. Microservice data 310, microservices 312, 314, 316, and 318, and analysis result 320 are the same as microservice data 310, microservices 312, 314, 316, and 318, and analysis result 320 in FIG. 3.

Here, new functionality module 230 receives new functionality 410-a date/time function is needed. Module 230 uses analysis result 320 to identify microservice 318 as having above a threshold similarity to new functionality 410, and identifies a set of differences between microservice 318 and new functionality 410, and uses microservice 318 and the set of differences to formulate new functionality implementation plan 420: use microservice 318 to implement new functionality 410.

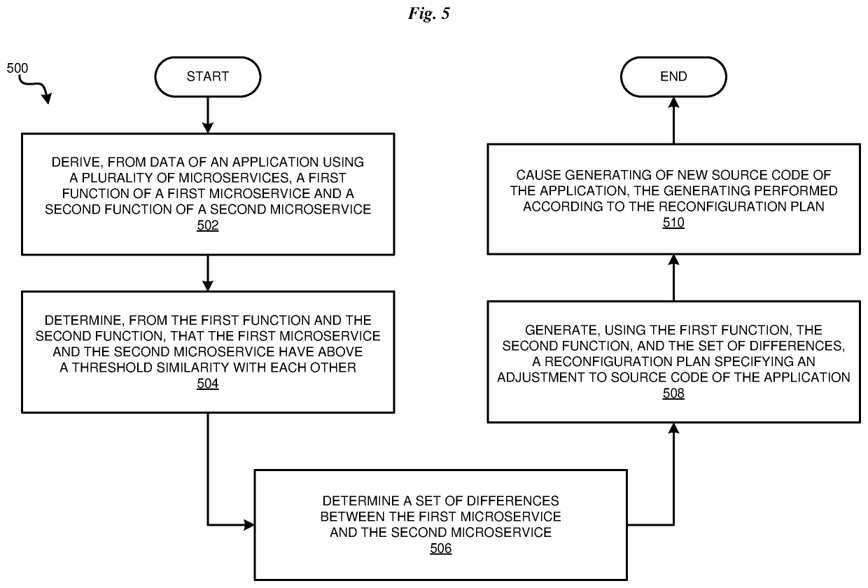

With reference to FIG. 5, this figure depicts a flowchart of an example process for dynamic microservices management and code generation in accordance with an illustrative embodiment. Process 500 can be implemented in application 200 in FIG. 2.

In block 502, the application derives, from data of an application using a plurality of microservices, a first function of a first microservice and a second function of a second microservice. In block 504, the application determines, from the first function and the second function, that the first microservice and the second microservice have above a threshold similarity with each other. In block 506, the application determines a set of differences between the first microservice and the second microservice. In block 508, the application generates, using the first function, the second function, and the set of differences, a reconfiguration plan specifying an adjustment to source code of the application. In block 510, the application causes generating of new source code of the application, the generating performed according to the reconfiguration plan. Then the application ends.

Thus, a computer implemented method, system or apparatus, and computer program product are provided in the illustrative embodiments for dynamic microservices management and code generation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
deriving, from data of an application using a plurality of microservices, a first function of a first microservice and a second function of a second microservice;
determining, from the first function and the second function, that the first microservice and the second microservice have above a threshold similarity with each other;
determining a set of differences between the first microservice and the second microservice; and
causing generating of new source code of the application, the new source code utilizing the first microservice instead of the second microservice, the first microservice selected using the set of differences.

2. The computer-implemented method of claim 1, further comprising:
generating, using the first function, the second function, and the set of differences, a reconfiguration plan specifying an adjustment to source code of the application, the generating performed according to the reconfiguration plan.

3. The computer-implemented method of claim 1, wherein the new source code comprises an adjustment to the first microservice to use an optional calling parameter.

4. The computer-implemented method of claim 1, wherein the generating further comprises removing, from the application, source code of the second microservice.

5. The computer-implemented method of claim 1, further comprising:
deriving, from data of the application using a plurality of microservices, a third function of a first portion of a third microservice and a fourth function of a second portion of the third microservice;
determining, from the first function and the third function, that the first microservice and the first portion of the third microservice have above a threshold similarity with each other;
determining a second set of differences between the first microservice and the third microservice; and
causing generating of a second portion of new source code of the application, the second portion of the new source code utilizing the first microservice instead of the first portion of the third microservice, the first microservice selected using the second set of differences.

6. The computer-implemented method of claim 1, further comprising:
deriving, from data of a candidate microservice, a candidate function of the candidate microservice;
determining, from the first function and the candidate function, that the first microservice and the candidate microservice have above a threshold similarity with each other;
determining a set of differences between the first microservice and the candidate microservice; and
causing generating of a third portion of new source code of the application, the third portion of the new source code utilizing the first microservice to perform the candidate function.

7. The computer-implemented method of claim 6, further comprising:
determining, from the candidate function, that the candidate microservice has below a threshold similarity with any existing microservice; and
causing generating of a fourth portion of new source code of the application, the fourth portion of the new source code implementing the candidate function.

8. A computer program product comprising one or more computer readable storage medium, and program instructions collectively stored on the one or more computer readable storage medium, the program instructions executable by a processor to cause the processor to perform operations comprising:
deriving, from data of an application using a plurality of microservices, a first function of a first microservice and a second function of a second microservice;
determining, from the first function and the second function, that the first microservice and the second microservice have above a threshold similarity with each other;
determining a set of differences between the first microservice and the second microservice; and
causing generating of new source code of the application, the new source code utilizing the first microservice instead of the second microservice, the first microservice selected using the set of differences.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, further comprising:
generating, using the first function, the second function, and the set of differences, a reconfiguration plan specifying an adjustment to source code of the application, the generating performed according to the reconfiguration plan.

12. The computer program product of claim 8, wherein the new source code comprises an adjustment to the first microservice to use an optional calling parameter.

13. The computer program product of claim 8, wherein the generating further comprises removing, from the application, source code of the second microservice.

14. The computer program product of claim 8, further comprising:
deriving, from data of the application using a plurality of microservices, a third function of a first portion of a third microservice and a fourth function of a second portion of the third microservice;
determining, from the first function and the third function, that the first microservice and the first portion of the third microservice have above a threshold similarity with each other;
determining a second set of differences between the first microservice and the third microservice; and
causing generating of a second portion of new source code of the application, the second portion of the new source code utilizing the first microservice instead of the first portion of the third microservice, the first microservice selected using the second set of differences.

15. The computer program product of claim 8, deriving, from data of a candidate microservice, a candidate function of the candidate microservice;
determining, from the first function and the candidate function, that the first microservice and the candidate microservice have above a threshold similarity with each other;
determining a set of differences between the first microservice and the candidate microservice; and
causing generating of a third portion of new source code of the application, the third portion of the new source code utilizing the first microservice to perform the candidate function.

16. The computer program product of claim 15, further comprising:
determining, from the candidate function, that the candidate microservice has below a threshold similarity with any existing microservice; and
causing generating of a fourth portion of new source code of the application, the fourth portion of the new source code implementing the candidate function.

17. A computer system comprising a processor and one or more computer readable storage media, and program instructions collectively stored on the one or more computer readable storage media, the program instructions executable by the processor to cause the processor to perform operations comprising:
deriving, from data of an application using a plurality of microservices, a first function of a first microservice and a second function of a second microservice;
determining, from the first function and the second function, that the first microservice and the second microservice have above a threshold similarity with each other;
determining a set of differences between the first microservice and the second microservice; and
causing generating of new source code of the application, the new source code utilizing the first microservice instead of the second microservice, the first microservice selected using the set of differences.

18. The computer system of claim 17, further comprising:
generating, using the first function, the second function, and the set of differences, a reconfiguration plan specifying an adjustment to source code of the application, the generating performed according to the reconfiguration plan.

19. The computer system of claim 17, wherein the new source code comprises an adjustment to the first microservice to use an optional calling parameter.

20. The computer system of claim 17, wherein the generating further comprises removing, from the application, source code of the second microservice.
